(19) United States
(12) Patent Application Publication
(10) Pub. No.: US 2014/0157009 A1
(43) Pub. Date: Jun. 5, 2014

(54) Opportunistic Modem Wakeup

(71) Applicant: BROADCOM CORPORATION, Irvine, CA (US)

(72) Inventor: Arzad KHERANI, Bangalore (IN)

(73) Assignee: Broadcom Corporation, Irvine, CA (US)

(21) Appl. No.: 13/706,020

(22) Filed: Dec. 5, 2012

(51) Int. Cl. G06F 1/32

(52) U.S. Cl. CPC G06F 1/32
USPC 713/300

(57) ABSTRACT

Embodiments provide methods and systems for enabling opportunistic wakeup of a device from a sleep mode. Specifically, embodiments recognize that often incoming packets into a module in a low power mode are not time-critical and can be deferred for processing by the module after a scheduled wakeup time of the module. As such, embodiments provide methods and systems for identifying an incoming packet into a module and determining whether or not to cause the module to exit the low power mode based on characteristics of the incoming packet. Embodiments may be applied to a modem in a wired or wireless device but are not limited as such, and extend to any device which may benefit from the opportunistic wakeup embodiments described herein.

### FIELD OF THE INVENTION

The present disclosure relates generally to modem wakeup and sleep modes.

### BACKGROUND

### Background Art

A LTE (Long Term Evolution) feature, known as Discontinuous Reception (DRx), allows a User Equipment (UE) to discontinue monitoring a downlink control channel in specified periods of time (DRx inactivity periods). The DRx inactivity periods are known to the evolved NodeB (eNB) (base station) of the LTE network, which does not schedule any downlink transmission to the UE during these periods. The UE can thus enter into a DRx inactive state if desired and also enter a sleep mode by putting one or more components, including the modem, for example, in a low power mode.

Because the eNB does not schedule any downlink transmission to the UE while in the DRx inactive state, the choice as to whether to enter and how long to stay in the sleep mode while in the DRx inactive state (e.g., whether to remain in the sleep power mode for the entire DRx inactivity period or exit the sleep mode before the end of the DRx inactivity period) rests with the UE.

Conventionally, the UE is often caused to exit the sleep mode prematurely (sometimes soon after entering it) due to incoming packets coming into the modem from other components of the UE (e.g., the application processor (AP)), which cause the modem to exit its low power mode.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 is a block diagram that illustrates an example device according to an embodiment.

FIG. 2 is a block diagram that illustrates an example processor module according to an embodiment.

FIG. 3 is a flowchart of a process for controlling wakeup of a modem according to an embodiment.

FIG. 4 is a flowchart of another process for controlling wakeup of a modem according to an embodiment.

FIG. 5 illustrates an example computer system that can be used to implement aspects of the present disclosure.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

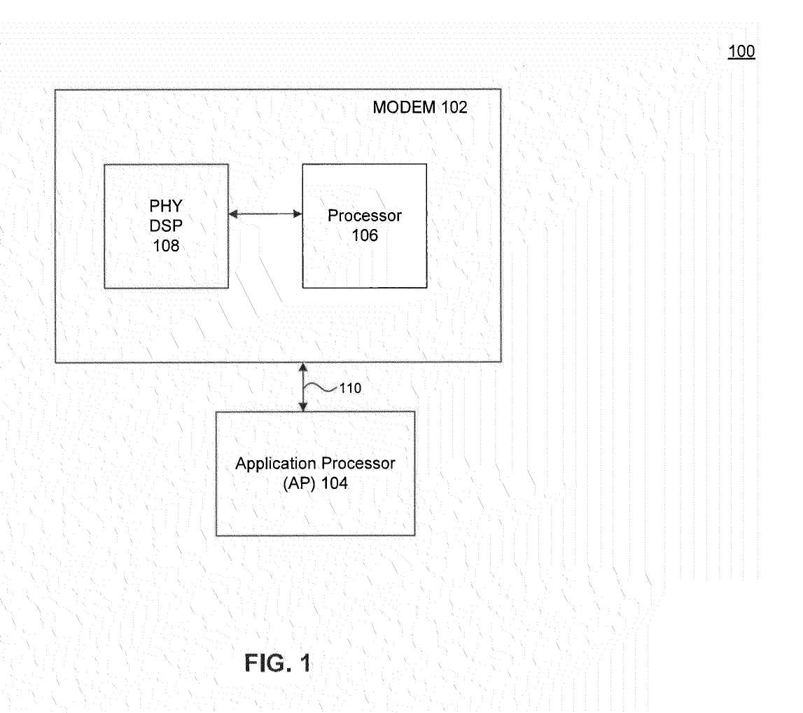

FIG. 1 is a block diagram that illustrates an example device 100 according to an embodiment. Example device 100 is provided for the purpose of illustration only and is not limiting of embodiments. Device 100 may be a wired or a wireless device. For example, device 100 may be a cable modem, a smart phone, or a tablet personal computer. As shown in FIG. 1, example device 100 includes a modem 102 and an application processor (AP) 104. In embodiments, modem 102 and AP 104 may be implemented on same or separate integrated circuits.

AP 104 may enable various Internet Protocol (IP)-based applications, including data, audio (e.g., voice, streaming music, etc.), and/or video applications. For example, AP 104 may support a variety of IP Multimedia Subsystem (IMS)-based applications and associated user interfaces (UIs), such as a Voice over IP (VoIP) and/or a Short Messaging Service (SMS) application and user interface. In addition, AP 104 may support various protocol stacks, which are formed from various supported application layer protocols, transport layer protocols, and Internet layer protocols. For example, AP 104 may support an “IP” stack, which includes the Transmission Control Protocol (TCP) and/or the User Datagram Protocol (UDP) over the Internet Protocol (IP). The IP stack underlies various supported application level protocols, including, for example and without limitation, the Real-time Transport Protocol (RTP), the Real-time Transport Control Protocol (RTCP), the Session Initiation Protocol (SIP), the Hypertext Transfer Protocol (HTTP), and/or the XML Configuration Access Protocol (XCAP).

As shown in FIG. 1, AP 104 communicates with modem 102 using an interface 110. Interface 110 may be an SDIO (Secure Digital Input Output) interface. In an embodiment, AP 104 uses modem 102 as a Layer-2 (L2) pipe that provides L-2 functions for IP-based traffic sent and received by AP 104. L-2 functions provided by modem 102 may include, without limitation, data link layer functions, Medium Access Control (MAC) layer functions, and Radio Link Control (RLC) functions. In addition, AP 104 may use modem 102 for baseband processing functions, including, without limitation, channel encoding/decoding, line coding/decoding, modulation/demodulation, etc. As such, modem 102 may serve as a bridge between AP 104 and a radio frequency integrated circuit (RFIC) module (not shown in FIG. 1) responsible for physical layer RF transmission/reception of information.

Modem 102 may be a wired or a wireless modem. In the case that modem 102 is a wireless modem, modem 102 may implement a variety of wireless technologies, including 2G (e.g., GSM, etc.), 2.5G (e.g., GPRS, etc.), 3G (EDGE, WCDMA, CMDA2000, etc.), and 4G (e.g., LTE, WiMAX, etc.). As shown in FIG. 1, modem 102 includes, without limitation, a processor 106 and a physical layer (PHY) digital signal processing (DSP) module 108. In other embodiments, modem 102 may include additional processors, for example.

Processor 106 may be a chip-level general controller. Processor 106 may thus perform general housekeeping functions, including boot up, configuration, and management functions with respect to various components of modem 102. For example, as further described below, processor 106 may control the wake up from a low power mode of PHY DSP 108 and/or of other components of modem 102. As such, processor 106 may drive various interfaces for communicating with other components of modem 102. In addition, processor 106 may drive interface 110 for communicating with AP 104.

In addition, processor 106, alone or in combination with other processors (not shown in FIG. 1), may implement one or more L-2 protocol stacks. For example, processor 106 may support various data link layer protocols, MAC layer protocols, and RLC protocols. L-2 protocols are defined by mobile phone technologies, including 3G and 4G technologies. Certain L-2 protocols may be common to more than one technology. In an embodiment, processor 106 provides a L-2 data pipe for AP 104 via interface 110. Accordingly, in the downlink, processor 106 receives L-2 traffic from DSP PHY 108 and relays it as IP traffic to AP 104. In the uplink, processor 106 receives IP traffic from AP 104 and relays it as L-2 traffic to PHY DSP 108.

PHY DSP 108 implements a physical layer of a wireless technology. This may include, without limitation, baseband processing functions, channel encoding/decoding, line coding/decoding, modulation/demodulation, etc. For example, PHY DSP 108 may implement a variety of baseband processing functions in accordance with various mobile phone standards, including, for example and without limitation, LTE, WiMAX, EDGE, etc. In an embodiment, PHY DSP 108 acts as a bridge between processor 106 and a RFIC module (not shown in FIG. 1) responsible for physical layer RF transmission/reception of information. Specifically, in the downlink, PHY DSP 108 receives baseband traffic from the RFIC module and relays it as L-2 traffic to processor 106. In the uplink, PHY DSP 108 receives L-2 traffic from processor 106 and relays it as baseband traffic to the RFIC module.

in some embodiments, modem 102 (including PHY DSP 108 and/or processor 106) may enter into a low power mode. The low power mode is a mode with low or no current consumption, in which some parts or all of modem 102 are turned off. In some embodiments, the low power mode may be enabled by particular features of the mobile phone technology in use by modem 102. For example, a 3G LTE feature, known as Discontinuous Reception (DRx), allows a User Equipment (UE) to discontinue monitoring a downlink control channel in specified periods of time (DRx inactivity periods). The DRx inactivity periods are known to the evolved NodeB (eNB) (base station) of the LTE network, which does not schedule any downlink transmission to a UE during these periods. The UE can thus enter into a DRx inactive state and also enter a sleep mode (by putting in a low power mode certain components, such as modem 102, the RFIC module, etc.) while in the DRx inactive state to save power.

Because the eNB does not schedule any downlink transmission to the UE while in a DRx inactive state, the choice as to whether to enter and how long to stay in the sleep mode while in the DRx inactive state (e.g., whether to remain in the sleep power mode for the entire DRx inactivity period or exit the sleep mode before the end of the DRx inactivity period) rests with the UE. Conventionally, however, the UE is often caused to exit the sleep mode prematurely (sometimes soon after entering it) due to incoming packets coming into the modem (e.g., modem 102 in example device 100) from other components (e.g., AP 104 in example device 100) of the UE, which cause the modem to exit its low power mode. The incoming packets may be data packets (for example, IP-based communication), data path control packets (control packets that enable or maintain the data path), or modem control packets for controlling the operation of the modem (for example, specific commands from the user to search for Public Land Mobile Net works (PLMNs), activate/deactivate Public Data Network (PDN) connections, fetch information from the Universal Subscriber Identity Module (USIM)). This leads to inefficiencies both in terms of time and power consumption because turning on modem 102 (and/or PHY DSP 108) requires significant time and high power consumption.

Embodiments provide methods and systems for enabling opportunistic wakeup of a device from a sleep mode. Specifically, embodiments recognize that incoming packets coming into a module in low power mode (e.g., modem 102) are not necessarily always time-critical and can be deferred for processing by the module after a scheduled wakeup time of the module or can be responded to by the module without completely waking every component (e.g., in a modem, the PHY may not need to be woken up). As such, embodiments provide methods and systems for identifying an incoming packet into a module and determining whether or not to cause the module to exit the low power mode based on characteristics of the incoming packet.

Example embodiments will be described below with particular application to a modem (e.g., modem 102) being the module in low power mode. The example embodiments will be described as being implemented in a processor module, such as processor 106, for example. As would be understood by a person of skill in the art based on the teachings herein, embodiments are not limited to these example embodiments and can be applied to any module in a device. Further, a person of skill in the art would understand based on the teachings herein that embodiments are not limited to a UE (LTE) device or to sleep modes enabled by DRx inactivity periods, but extend to any device, wired or wireless, which may benefit from the opportunistic wakeup embodiments described herein, so that the device can be intelligently woken up from a sleep mode to reduce time delay and power consumption associated with frequent mode change (from normal mode to low power mode, and vice versa).

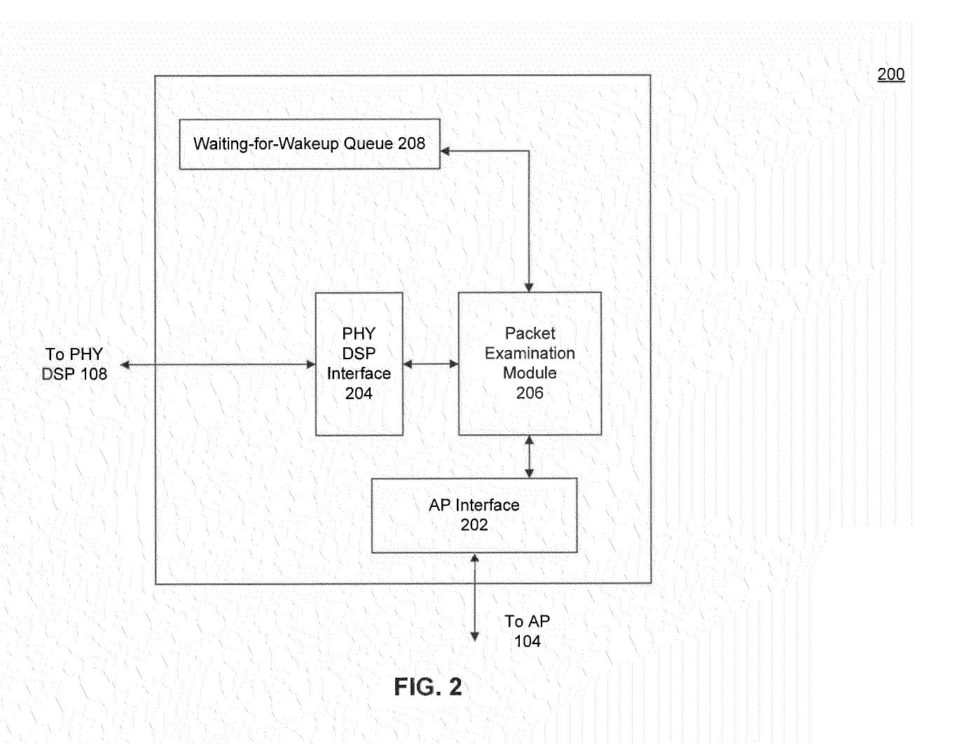

FIG. 2 is a block diagram that illustrates an example processor module 200 according to an embodiment. Example processor module 200 is provided for the purpose of illustration only and is not limiting. Example processor module 200 may be an embodiment of processor 106 described above in FIG. 1, and can be used to implement embodiments within a modem, such as modem 102. As shown in FIG. 2, example processor module 200 includes, among other components, an AP interface 202 for interfacing with an AP 104, a PHY DSP interface 204 for interfacing with a PHY DSP 108, a packet examination module 206, and a waiting-for-wakeup queue 208.

In some embodiments, parts of processor 200 may be placed in low power mode along with other modules, e.g., PHY DSP 108, of the modem in which processor 200 resides. While in the low power mode, one or more of AP interface 202, PHY DSP interface 204, packet examination module 206, and queue 208 may remain turned on to perform embodiments (or, may be forced to be on in event of an activity on AP interface 202). Specifically, while in the low power mode, packet examination module 206 may receive a packet from AP 104 via AP interface 202. The incoming packet may include, for example and without limitation, at least one of: a data packet, a data path control packet, a modem control packet, an application-specific keep-alive message, a Layer-3 control packet, a Layer-2 control packet, a Transmission Control Protocol (TCP) keep-alive message, and a Session Initiation Protocol (SIP) keep-alive message.

Based on characteristics of the incoming packet (and optionally taking into account the state of waiting-for-wakeup queue 208 and/or other LTE protocol specific parameters associated with the flow that the incoming packet belongs to), packet examination module 206 determines whether or not to wake up PHY DSP 108 from low power mode (before a scheduled wakeup time). In an embodiment, the decision of waking up the parts of processor 200 that are currently in low power mode may be tied to the decision of waking up PHY DSP 108. As such, in the following, for ease of presentation, embodiments are described only with reference to the decision to wake up PHY DSP 108, with the understanding that the parts of processor 200 that may be in low power mode can also be controlled together with PHY DSP 108.

In an embodiment, in determining whether or not to wake up PHY DSP 108 from low power mode, packet examination module 206 is configured to determine whether or not uplink transmission of the incoming packet is required before the scheduled wakeup time. If uplink transmission of the packet is not required, then PHY DSP 108 is not woken up from the low power mode by packet examination module 206. For example, the packet may be a modem control packet (e.g. Attention (AT) command) for controlling the operation of the modem in which processor 200 resides. Accordingly, packet examination module 206 enqueues the packet in queue 208 for deferred processing by PHY DSP 108 upon wakeup at the scheduled wakeup time. Alternatively, the packet may be of a type that is either dropped inside the modem or responded to by the modem (e.g., several IPv4/v6 configuration messages do not require uplink transmission and are either dropped inside the modem or are replied to by the modem). Accordingly, packet examination module 206 either drops the packet and/or sends a reply packet to AP 104 in response to the packet via AP interface 202.

If uplink transmission of the packet is required, then packet examination module 206 is configured to determine whether the packet should be transmitted at a current time or a future time. If the packet should be transmitted at the current time, then packet examination module 206 is configured to wake up PHY DSP 108 and to forward the packet to PHY DSP 108 via PHY DSP interface 204 for uplink transmission.

Examples in which the packet should be transmitted at the current time include: the packet includes a time critical message (e.g., a time critical keep-alive message); the number of enqueued packets associated with the traffic radio bearer of the packet (e.g., MAC-level bucket size) is greater than a predetermined or dynamic threshold; the current time plus a remaining packet delay budget associated with the packet is less than the scheduled wakeup time of the modem (the packet will violate its Quality of Service (QoS) profile if not transmitted before the scheduled wakeup time); and/or a fill level of queue 208 exceeds a predefined or dynamic threshold.

Alternatively, if the packet should be transmitted at a future time, then packet examination module 206 is configured to enqueue the packet in queue 208 for deferred processing by PHY DSP 108 upon wakeup at the scheduled wakeup time. In an embodiment, packet examination module 206 is further configured to compare the future time to the scheduled wakeup time of PHY DSP 108 and, if the future time is before the scheduled wake up time, to advance the scheduled wakeup time of PHY DSP 108 to the future time.

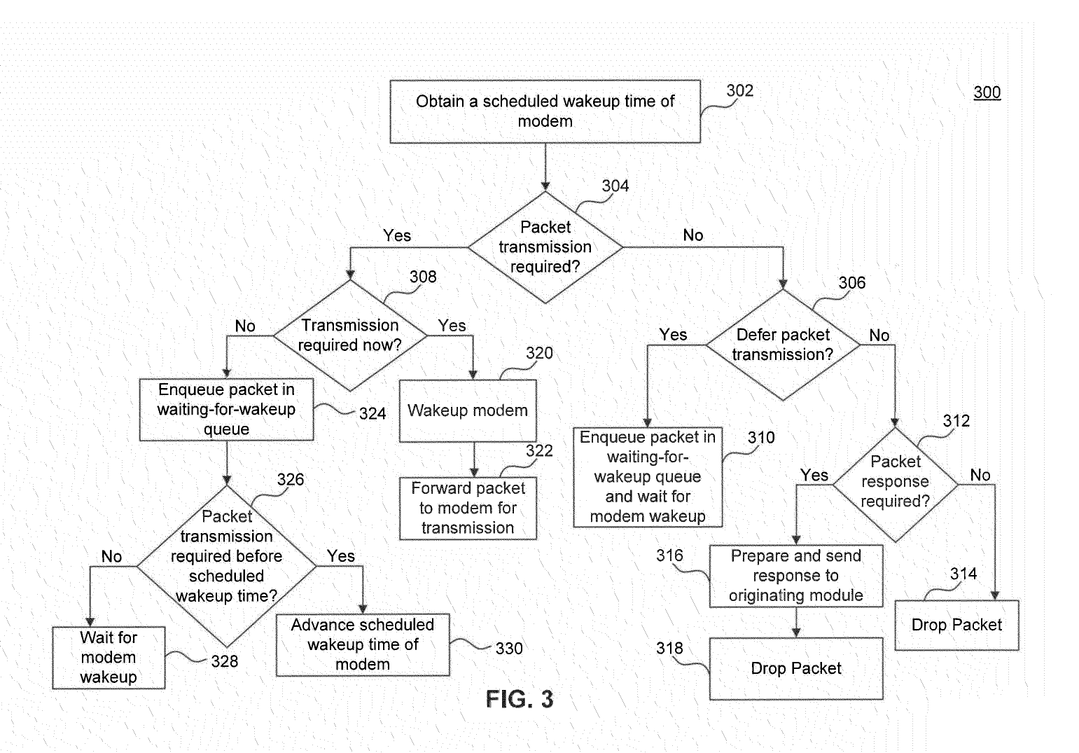

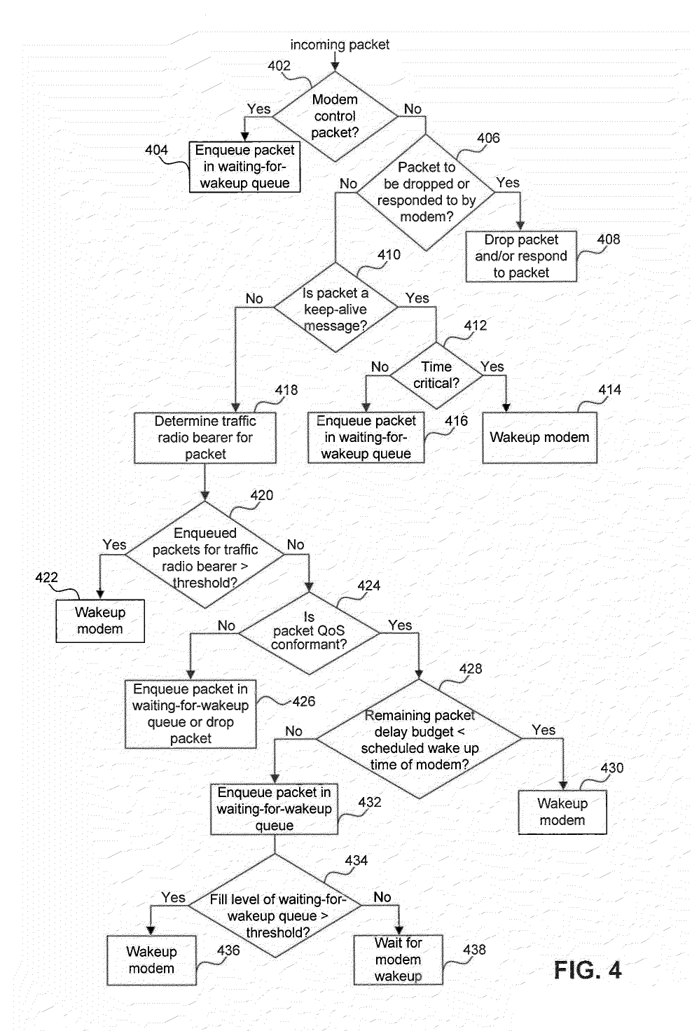

In the following, example processes for controlling the wakeup of a modem, including its PHY DSP module, for example, are described with reference to FIGS. 3 and 4. The example processes can be performed by a packet examination module (e.g., packet examination 206) of a processor (e.g., processor 200 or processor 106) within the modem, or by another module outside the modem. The modem is assumed to be in low power mode at the beginning of each of the example processes.

FIG. 3 is a flowchart of a process 300 for controlling wakeup of a modem according to an embodiment. Process 300 is provided for the purpose of illustration only and is not limiting of embodiments. Process 300 is triggered by receiving a packet destined to the modem from another module, such as an AP, for example.

As shown in FIG. 3, process 300 begins in step 302, which includes obtaining a scheduled wakeup time of the modem. In an embodiment, the scheduled wakeup time of the modem is based on an anticipated inactivity period for the device in which the modem resides. For example, the scheduled wakeup time may be at the end of a DRx inactivity period for a LTE device.

Subsequently, step 304 includes determining whether or not the incoming packet must be transmitted by the modem. As mentioned, in some cases, the incoming packet may be a packet for which transmission is not required. In such cases, process 300 proceeds to step 306, which includes determining whether to defer transmission of the packet (even though transmission is not obligatory). For example, the packet may be of a type that can be dropped but may be enqueued for deferred transmission if the scheduled wakeup time is less than a predefined duration from the current time.

If the answer to step 306 is yes, then process 300 proceeds to step 310, which includes enqueueing the packet in a waiting-for-wakeup queue for deferred processing by the modem upon wakeup at the scheduled wake up time. Otherwise, process 300 proceeds to step 312, which includes determining whether a response to the packet is required. As mentioned above, certain incoming packets to the modem are replied to by the modem. Process 300 proceeds to step 316 if a response is required. Step 316 includes preparing and sending a response to the originating module of the packet. For example, step 316 may include the modem sending a response to the AP. Subsequently, the packet is dropped in step 318. If no response is required to the packet, then process 300 proceeds to step 314, which includes dropping the packet.

Returning to step 304, if packet transmission is required in step 304, then process 300 proceeds to step 308, which includes determining whether transmission of the packet is required at the current time. Examples in which the packet should be transmitted at the current time include: the packet includes a time critical message (e.g., a time critical keep-alive message); the number of enqueued packets associated with the traffic radio bearer of the packet (e.g., MAC-level bucket size) is greater than a predetermined threshold; the current time plus a remaining packet delay budget associated with the packet is less than the scheduled wakeup time of the modem (the packet will violate its QoS profile if not transmitted before the scheduled wakeup time); and/or a fill level of the waiting-for-wakeup queue exceeds a predefined threshold.

If packet transmission is required at the current time, then process 300 proceeds to step 320, which includes waking up the modem, and then to step 322, which includes forwarding the packet to the modem for transmission. Otherwise, if packet transmission is required at a future time, process 300 proceeds to step 324, which includes enqueueing the packet in the waiting-for-wakeup queue for deferred processing by the modem upon wakeup at the scheduled wakeup time. Subsequently, step 326 includes determining whether packet transmission is required before the scheduled wakeup time of the modem. If yes, then the scheduled wakeup time of the modem is advanced to the future time (at which packet transmission is required) in step 330. Otherwise, process 300 proceeds to step 328, which includes waiting for the modem to wake up at the scheduled wakeup time (by returning to low power mode).

FIG. 4 is a flowchart of another process 400 for controlling wakeup of a modem according to an embodiment. Process 400 is provided for the purpose of illustration only and is not limiting of embodiments. Process 400 is triggered by receiving a packet destined to the modem from another module, such as an AP, for example.

As shown in FIG. 4, process 400 begins in step 402, which includes determining whether or not the received packet includes a modem control packet for controlling the operation of the modem. Modem control packets are not transmitted on the uplink by the modern and generally are not of time-critical nature. As such, if the answer in step 402 is yes, process 400 proceeds to step 404, which includes enqueueing the packet in a waiting-for-wakeup queue for deferred processing by the modern after a scheduled wakeup time of the modem. Otherwise, process 400 proceeds to step 406.

Process 406 includes determining whether or not the packet is a packet to be dropped or responded to by the modem (e.g., several IPv4/v6 configuration messages do not require uplink transmission and are either dropped inside the modem or are replied to by the modem). If the answer to step 406 is yes, then process 400 proceeds to step 408, which includes responding to the packet and/or dropping the packet. Otherwise, process 400 proceeds to step 410.

Step 410 includes determining whether the packet includes a keep-alive message. For example, step 410 includes determining whether the packet includes a Dynamic Host Control Protocol (DHCP) keep-alive message, a TCP keep-alive message, a SW keep-alive message, or other application-specific keep-alive message. In an embodiment, the packet examination module implements algorithms for detecting keep-alive messages without inspecting the contents of these messages. For example, TCP keep-alive messages include dummy uplink acknowledgments generated by the TCP client running on the AR In an embodiment, if after more than 10 msec from the modem entering the low power mode, a TCP acknowledgment is received by the modem from the AP then the acknowledgement is assumed to be a TCP keep-alive message. The reason behind this example heuristic is that the TCP client typically does not require this much time (more than 10 msec) to generate an acknowledgment for a received packet (received before the modern entered low power mode). In another embodiment, the heuristic is modified to account for the receipt of the acknowledgment by the modem from the time the AP exits a low power mode (rather than from the time the modern enters the low power mode).

SIP keep-alive messages can also be detected by the packet examination module based on known periodicity of the messages. For example, in an embodiment, if consecutive SIP messages are received at a periodic interval of 120 seconds with the modem in low power mode (and thus no data activity), then the SIP messages are assumed to be SIP keep-alive messages. SIP keep-alive messages are seen often by the modem when an IMS application (e.g., VoIP, SMS) is used.

Returning to step 410, if the answer to step 410 is yes, process 400 proceeds to step 412, which includes determining whether or not the keep-alive message is time-critical. For example, the keep-alive message is time-critical if delaying transmission of the message could cause an established session or data connection to be disconnected. In an embodiment, a keep-alive message is associated with a keep-alive interval, which indicates a periodic rate at which keep-alive messages (of the same type as the keep-alive message) should be transmitted. If a current time exceeds a last flow transmission activity time associated with the keep-alive message by more than the keep-alive interval, then the keep-alive message is considered time-critical.

if the answer to step 412 is yes, process 400 proceeds to step 414, which includes waking up the modern from the low power mode for immediate processing of the packet. Otherwise, process 400 proceeds to step 416, which includes enqueueing the packet in the waiting-for-wakeup queue for deferred processing by the modem after the scheduled wakeup time of the modem.

Returning to step 410, if the answer to step 410 is no, process 400 proceeds to step 418, which includes determining a traffic radio bearer associated with the packet, and then to step 420, which includes comparing a number of enqueued packets associated with the traffic radio bearer to a predetermined threshold. In an embodiment, step 420 further includes comparing a bucket size associated with a logical channel identifier (LCID) that corresponds to the traffic radio bearer carrying the packet with the predetermined threshold. The predetermined threshold may be a percentage of a bucket size depth (e.g., 75%) associated with the LCID.

If the number of enqueued packets associated with the traffic radio bearer is greater than the predetermined threshold in step 420, process 400 proceeds to step 422, which waking up the modem from the low power mode. Otherwise, process 400 proceeds to step 424, which includes determining whether or not the packet is QoS conformant. In an embodiment, the packet is QoS conformant if transmission of the packet at the current time does not cause a bit rate of the radio bearer carrying the packet to exceed a maximum bit rate (MBR).

If the answer to step 424 is no, process 400 proceeds to step 426, which includes enqueueing the packet in the waiting-for-wakeup queue for deferred processing by the modem after the scheduled wakeup time of the modern or dropping the packet. Otherwise, process 400 proceeds to step 428, which includes comparing a remaining packet delay budget associated with the packet to the scheduled wakeup time of the modern. In an embodiment, the packet delay budget of a packet defines an upper time limit on the delay that the packet can experience between the device (in which the modem resides) and another node in the network (e.g., gateway node). The packet delay budget is initially set based on the QoS profile of the bearer carrying the packet and is then decreased with time.

If the current time plus the remaining packet delay budget associated with the packet is less than the scheduled wakeup time of the modem in step 428, process 400 proceeds to step 430, which includes waking up the modem from the low power mode. This occurs if the packet would violate its QoS profile if not transmitted before the scheduled wakeup time. Otherwise, process 400 proceeds to step 432, which includes enqueueing the packet for deferred processing by the modern after the scheduled wakeup time of the modem, and then to step 434.

Step 434 includes comparing a fill level of the waiting-for-wakeup queue of the modem to a defined threshold. If the fill level is greater than the defined threshold, process 400 proceeds to step 436, which includes waking up the modern. Otherwise, process 400 proceeds to step 438, which includes waiting for the modem to wake up at the scheduled wakeup time. In an embodiment, the fill level is determined in terms of the number of bytes of packets queued in the waiting-for-wakeup queue, and the defined threshold is defined as the size of N uplink transmissions by the device in which the modem resides (where N is an integer). The size of an uplink transmission by the device may be a function of the device category and bandwidth available in a cell where the device is located.

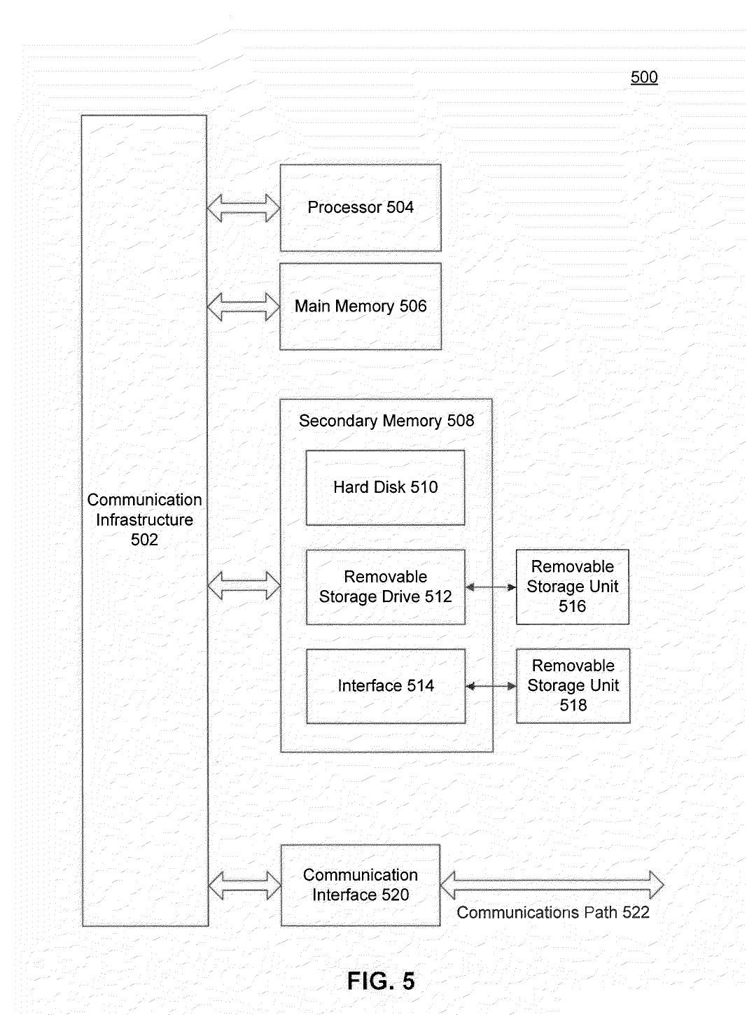

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 500 is shown in FIG. 5. Modules depicted in FIGS. 1 and 2 may execute on one or more computer systems 500. Furthermore, each of the steps of the flowcharts depicted in FIGS. 3 and 4 can be implemented on one or more computer systems 500.

Computer system 500 includes one or more processors, such as processor 504. Processor 504 can be a special purpose or a general purpose digital signal processor. Processor 504 is connected to a communication infrastructure 502 (for example, a bus or network). Various software implementations are described in terms of this exemplary computer system. After reading this description, it will become apparent to a person skilled in the relevant art(s) how to implement the disclosure using other computer systems and/or computer architectures.

Computer system 500 also includes a main memory 506, preferably random access memory (RAM), and may also include a secondary memory 508. Secondary memory 508 may include, for example, a hard disk drive 510 and/or a removable storage drive 512, representing a floppy disk drive, a magnetic tape drive, an optical disk drive, or the like. Removable storage drive 512 reads from and/or writes to a removable storage unit 516 in a well-known manner. Removable storage unit 516 represents a floppy disk, magnetic tape, optical disk, or the like, which is read by and written to by removable storage drive 512. As will be appreciated by persons skilled in the relevant art(s), removable storage unit 516 includes a computer usable storage medium having stored therein computer software and/or data.

In alternative implementations, secondary memory 508 may include other similar means for allowing computer programs or other instructions to be loaded into computer system 500. Such means may include, for example, a removable storage unit 518 and an interface 514. Examples of such means may include a program cartridge and cartridge interface (such as that found in video game devices), a removable memory chip (such as an EPROM, or PROM) and associated socket, a thumb drive and USB port, and other removable storage units 518 and interfaces 514 which allow software and data to be transferred from removable storage unit 518 to computer system 500.

Computer system 500 may also include a communications interface 520. Communications interface 520 allows software and data to be transferred between computer system 500 and external devices. Examples of communications interface 520 may include a modem, a network interface (such as an Ethernet card), a communications port, a PCMCIA slot and card, etc. Software and data transferred via communications interface 520 are in the form of signals which may be electronic, electromagnetic, optical, or other signals capable of being received by communications interface 520. These signals are provided to communications interface 520 via a communications path 522. Communications path 522 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 516 and 518 or a hard disk installed in hard disk drive 510. These computer program products are means for providing software to computer system 500.

Computer programs (also called computer control logic) are stored in main memory 506 and/or secondary memory 508. Computer programs may also be received via communications interface 520. Such computer programs, when executed, enable the computer system 500 to implement the present disclosure as discussed herein. In particular, the computer programs, when executed, enable processor 504 to implement the processes of the present disclosure, such as any of the methods described herein. Accordingly, such computer programs represent controllers of the computer system 500. Where the disclosure is implemented using software, the software may be stored in a computer program product and loaded into computer system 500 using removable storage drive 512, interface 514, or communications interface 520.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A method performed in a device having an application processor (AP) and a modem in a low power mode, comprising:
receiving a packet from the AP; and
determining whether or not to wake up the modem from the low power mode based on characteristics of the packet.

2. The method of claim 1, wherein said determining comprises determining whether the packet includes a modem control packet, and wherein if the packet includes the modem control packet, the method further comprises:
enqueueing the packet for deferred processing by the modem after a scheduled wakeup time of the modem.

3. The method of claim 1, wherein said determining comprises determining whether the packet includes a keep-alive message, and wherein if the packet includes the keep-alive message, the method further comprises:
enqueueing the packet for deferred processing by the modem after a scheduled wakeup time of the modem, if the keep-alive message is non-time critical; and
waking up the modem from the low power mode for immediate processing of the packet if the keep-alive is time critical,
wherein the keep-alive message is time critical if a current time exceeds a last flow transmission activity time associated with the keep-alive message by more than a keep-alive interval.

4. The method of claim 1, wherein said determining comprises:
determining a traffic radio bearer associated with the packet; and
comparing a number of enqueued packets associated with the traffic radio bearer to a predetermined threshold.

5. The method of claim 4, wherein the number of enqueued packets associated with the traffic radio bearer is greater than the predetermined threshold, further comprising:
waking up the modem from the low power mode.

6. The method of claim 4, wherein the number of enqueued packets associated with the traffic radio bearer is less than the predetermined threshold, further comprising:
determining if the packet is Quality of Service (QoS) conformant.

7. The method of claim 6, wherein the packet is not QoS conformant, further comprising:
dropping the packet.

8. The method of claim 6, wherein the packet is QoS conformant, further comprising:
comparing a remaining packet delay budget associated with the packet to a scheduled wakeup time of the modem;
waking up the modem from the low power mode if a current time plus the remaining packet delay budget associated with the packet is less than the scheduled wakeup time of the modem; and
enqueueing the packet for deferred processing by the modem after the scheduled wakeup time of the modem, if the current time plus the remaining packet delay budget associated with the packet is greater than the scheduled wakeup time of the modem.

9. The method of claim 8, wherein the remaining packet delay budget associated with the packet is greater than the scheduled wakeup time of the modem, further comprising:
comparing a fill level of a deferred processing queue of the modem to a defined threshold; and
waking up the modem if the fill level of a deferred processing queue of the modem is greater than the defined threshold.

10. A modem, comprising:
a digital signal processing (DSP) module configured to implement a physical layer of a wireless technology; and
a processor module configured to implement a packet examination module, the packet examination module configured to receive a packet from another processor module and to determine whether or not to wake up the DSP module from a low power mode based on characteristics of the packet.

11. The modem of claim 10, wherein the packet examination module is further configured to determine whether or not uplink transmission of the packet is required, and wherein if the uplink transmission of the packet is not required, the packet examination module is further configured to enqueue the packet for deferred processing by the DSP module, send a reply packet to the other processor in response to the received packet, or drop the received packet, without waking up the DSP module.

12. The modem of claim 10, wherein the packet examination module is further configured to determine whether or not uplink transmission of the packet is required, and wherein if the uplink transmission of the packet is required, the packet examination module is further configured to determine whether the packet should be transmitted at a current time or a future time.

13. The modem of claim 12, wherein if the packet should be transmitted at the current time, the packet examination module is configured to wake up the DSP module and to forward the packet to the DSP module for uplink transmission.

14. The modem of claim 12, wherein if the packet should be transmitted at a future time, the packet examination module is further configured to enqueue the packet for deferred processing by the DSP module.

15. The modem of claim 14, wherein the packet examination module is further configured to compare the future time to a scheduled wakeup time of the DSP module and, if the future time is before the scheduled wake up time, to advance the scheduled wakeup time of the DSP module to the future time.

16. The modem of claim 10, wherein the other processor is an application processor (AP) of a device comprising the modem, and wherein the packet includes at least one of: a data packet, a data path control packet, a modem control packet, an application-specific keep-alive message, a Layer-3 control packet, a Layer-2 control packet, a Transmission Control Protocol (TCP) keep-alive message, and a Session Initiation Protocol (SIP) keep-alive message.

17. A device, comprising:
an application processor (AP); and
a modem comprising:
a digital signal processing (DSP) module configured to implement a physical layer of a wireless technology; and
a processor module configured to implement a packet examination module, the packet examination module configured to receive a packet from the AP and to determine whether or not to wake up the DSP module from a low power mode based on characteristics of the packet.

18. The device of claim 17, wherein the packet examination module is further configured to determine a traffic radio bearer associated with the packet; compare a number of enqueued packets associated with the traffic radio bearer to a predetermined threshold; and wake up the DSP module from the low power mode if the number of enqueued packets associated with the traffic radio bearer is greater than the predetermined threshold.

19. The device of claim 18, wherein the number of enqueued packets associated with the traffic radio bearer is less than the predetermined threshold, the packet examination module further configured to determine if the packet is Quality of Service (QoS) conformant; and drop the packet if the packet is not QoS conformant.

20. The device of claim 19, wherein the packet is QoS conformant, the packet examination module further configured to:
compare a remaining packet delay budget associated with the packet to a scheduled wakeup time of the DSP module;
wake up the DSP module from the low power mode if a current time plus the remaining packet delay budget associated with the packet is less than the scheduled wakeup time of the modem; and
enqueue the packet for deferred processing by the DSP module after the scheduled wakeup time of the DSP module, if the current time plus the remaining packet delay budget associated with the packet is greater than the scheduled wakeup time of the modem.
